(19) United States
(12) Patent Application Publication
(10) Pub. No.: US 2008/0209781 A1
(43) Pub. Date: Sep. 4, 2008

(54) Device for displaying a disabled parking permit

(76) Inventor: Michael Victor Mortensen, Highland Beach, FL (US)

Correspondence Address: Michael V. Mortensen, 4511 South Ocean Blvd. # 301, Highland Beach, FL, 33487, US

(21) Appl. No.: 12/075,484

(22) Filed: Mar. 12, 2008

Related U.S. Application Data
(63) Continuation-in-part of application No. 11/440,285, filed on May 24, 2006, now abandoned.

(51) Int. Cl. G09F 11/08

(52) U.S. Cl. 40/517; 40/514

(57) ABSTRACT

A device for displaying a disabled parking permit includes a partially rounded housing with a flat fascia with a hook for hanging the device from a rear view mirror of an automobile. The disabled parking permit is required on opposite faces of a flexible sheet that is wound onto a spring loaded roll in order to contain it within the housing while driving. And this housing must not hang any lower than one and a quarter inch below the mirror. The placard can be pulled down from a slot opening on the bottom of the housing to a fully extended positioning order to display the disabled parking permit in a manner that allows visibility from both the front and the rear of the handicap persons automobile when the vehicle is parked. The placard must be retracted and rolled up within the housing, onto the spring-loaded roll, to avoid obstruction of view while driving. The width, length, colors, and indicia all being factors that must meet stringent municipal requirements. As well as the placard being registered with a displayed I.D. number to the driver of the automobile.

### FIELD OF THE INVENTION

The present invention relates to disabled parking permits, and, more particular, to a device for displaying a disabled parking permit in a retractable device, and wherein the device allows the placard to be extended in order to fully display the disabled parking permit when parked, and, further, wherein the device allows the placard to retract to avoid obstruction of view while driving.

### DISCUSSION OF THE RELATED ART

State motor vehicle laws provide for disabled parking permits that allow persons with either long-term or temporary mobility impairment to park in designated handicap parking spaces at public parking facilities. To qualify for a disabled parking permit, a person must be certified by a licensed physician or other qualified medical professional as having a disability that renders the person physically impaired. The disabled parking permit is provided currently on a placard that is placed in the disabled person's vehicle so that the placard is visible from the front and the rear of the vehicle when parked in a designated disabled parking space. In all cases, the placard must be hung from the support arm of the vehicles rear view mirror in order for it to be recognized by law enforcement governing those parking spaces. Each side of the placard must have the international symbol of handicap accessibility [i.e. stick figure illustration of a person seated in a wheel chair] in a white color with a blue color background in the center of the placard. The placard is normally provided with a cut out portion on the top that forms a hook for hanging the placard on the support arm of the rear view mirror. This allows the disabled parking permit to be displayed in the manner required by law when parked in the designated parking space. When driving, the placard is not needed and, when left hanging from the rear view mirror while driving, has been determined to present an obstruction to the drivers view. To avoid obstruction of view, and possible fine by law enforcement, the driver is instructed to remove the placard from the rear view mirror while driving. However, when parking in a designated disabled parking space, the driver often forgets to replace the placard on the rear view mirror so that the parking permit is displayed in the lawful manner. If the disabled parking permit is not displayed, by hanging the placard on the rear view mirror, the driver will be issued a citation requiring payment of a fine. To avoid having to pay a fine, the driver must appear in court in most cases, and present his registration proving his required permit.

Presently the placard for displaying a disabled parking permit continually exposes the driver to a potential citation or fine for either obstruction of view or failure to display the required permit. Accordingly, there remains an urgent need for a convenient and effective device to eliminate those consequence's, and allows a driver of a motor vehicle to properly display his or her permit when parked in a designated parking space whether the device is pulled down or retracted. Always knowing that this devise will meet requirements whether it is pulled down or not. And never have to be removed due to its detractive nature and size.

### OBJECTS AND ADVANTAGES OF THE INVENTION

Considering the foregoing, it is a primary object of the present invention to provide a device for displaying a disabled parking permit on a retractable placard, and wherein the device allows the placard to be extended in order to fully display the disabled parking permit when parked in a designated handicap parking space and, further, wherein the device allows the placard to retract into a housing in order to avoid obstruction of view when driving a vehicle [car/truck].

It is further object of the present invention to provide a device for displaying a disabled parking permit number and handicap symbol, whether the placard is pulled down or retracted. And while retracted and driving the vehicle, never having to worry about obstruction of view due to the housing size and hanging length below the automobiles rear view mirror.

It is still a further object of the present invention to provide a device for conveniently displaying a disabled parking permit on a placard which is retractable from view when driving and, wherein the device is simple to use and easily installed in any automobile by hanging the device on the support arm of the rear view mirror.

These and other objects and advantages of the invention are more readily apparent with reference to the detailed description and drawings.

### SUMMARY OF THE INVENTION

The present invention is directed to a device for displaying a disabled parking permit in an automobile when parked in a designated handicap parking space. The device includes a housing, no more than an inch and a quarter in diameter, with a hook for hanging the device from a rear view mirror in an automobile. The disabled parking permit number and international symbol of handicap accessibility is provided on opposite faces of a flexible sheet placard that is wound onto a spring loaded roll contained within the housing. The placard can be pulled down from the slot opening on the bottom of the housing to a fully extended position for displaying the disabled parking permit in a manner that allows visibility from both the front and the rear of the vehicle when the automobile is parked. The placard retracts and rolls up within the housing, onto the spring loaded roll, to avoid obstruction of view when driving the auto.

### BRIEF DESCRIPTION OF DRAWINGS

For a fuller understanding of the nature of the present invention, reference should be made to the following detailed description taken in conjunction with the accompanying drawings in which:

FIG. 1 is a front perspective view of the disabled parking permit display device of the present invention shown with the placard in a fully extended position to display the disabled parking permit;

FIG. 2 is a perspective view of the device with the placard in a retracted position;

FIG. 3 is a side lavational view, in partial cross-section, showing the placard the placard wound onto a spring loaded roll within the housing device when in the retracted position;

FIG. 4 is a front plan view, taken from the exterior of an automobile and looking through the front windshield, showing the device hanging from a rear view mirror with the placard in the extended position to display the disabled parking permit; and

FIG. 5 is a plan view looking forward from within the vehicle and showing the device hanging from the rear view mirror with the placard in the extended position to display the disabled parking permit.

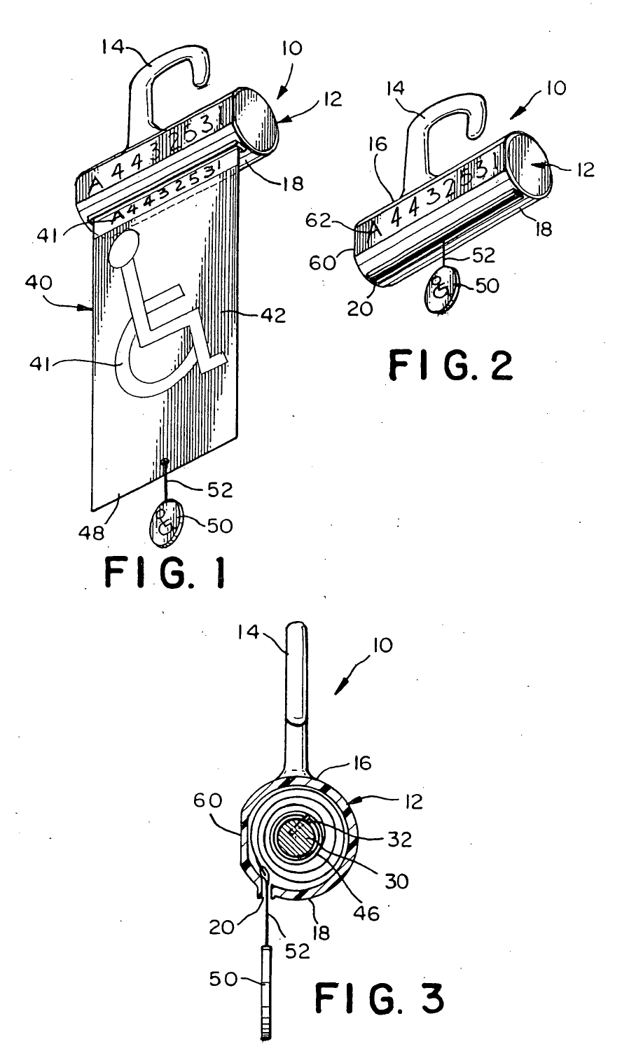

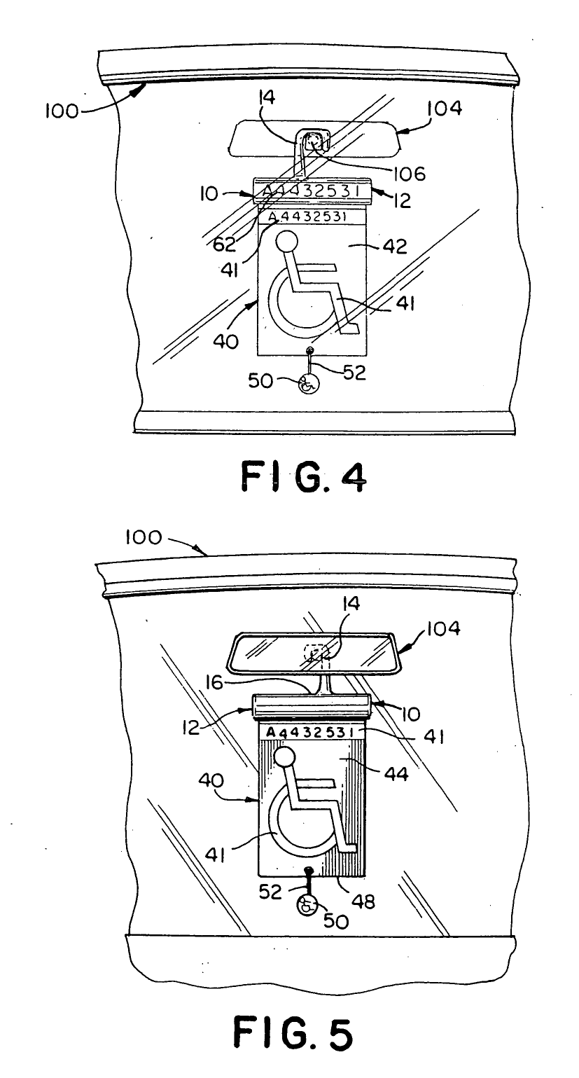

Like reference numerals refer to the like parts throughout the several views of the drawings

### DETAILED DESCRIPTION OF THE PREFERRED EMBODIMENT

As shown throughout several views of the drawing, the present invention is directed to a device for displaying a disabled parking permit in an automobile when parked in a designated handicap parking space. The device generally indicated as 10, includes a housing 12 that is formed out of a rigid material, such as molded plastic, with a hook 14 extending from the top 16 for hanging the device 10 on the support arm 106 of a rear view mirror 104 in the automobile 100. The housing 12 includes a slot opening 20 along the bottom 18 communicating with an interior chamber 22. A spring loaded roll 30 is rotatably supported with the interior chamber 22. The roll 30 operates in a manner similar to a roll-up window shade.

A placard 40 is provided on a flexible sheet substrate and exhibits the disabled parking permit which is displayed by indicia 41 on both sides 42, 44 of the placard. A top end 46 of the placard 40 is attached to the spring loaded roll 30 and, when in a retracted position, the placard 40 is wound about the roll 30 within the housing 12. A pull tab 50 with a connecting cord 52 extends from a bottom edge 48 of the placard and remains accessible on an exterior of the housing, hanging down from the slot opening 20. By pulling downwardly on a tab 50, the placard 40 is unrolled and extended from the slot opening 20 until reaching a fully extended position that visibly exposes the disabled parking permit on both the front and rear faces 42, 44 of the placard. When reaching the fully extended position, the downward pull on the tab 50 is released and the spring loaded roll 30 locks against the potential energy of the spring 32.

In the fully extended position, the disabled parking permit is visible from the front and rear windows of the automobile, as required by law. By applying a short downward tug on the pull tab 50, the spring-loaded roll 30 is released from the locked position, allowing the stored energy of the spring within the roll to rotate the roll 30 in a wind up action, similar to a roll up window shade. This causes the placard 40 to be wound onto the roll 30 within the housing 12, thereby effectively retracting the placard 40 from view. The placard 40 retracts and rolls up within the housing 12, onto the spring loaded roll 30, to avoid obstruction of view when driving.

In a preferred embodiment, the housing 12 and the hook 14 are integrally molded as one piece and a designated area 60 is formed on the housing exterior [e.g. a flat surface] for attaching a decal 62 that contains the user's disabled parking permit I D number.

While the instant invention has been shown and described in accordance with a preferred and practical embodiment thereof, it is recognized that departures from the instant disclosure are contemplated within the spirit and scope of the present invention.

What is claimed is:

1. A device for displaying a disabled parking permit within a automobile, having a rear view mirror held on a support arm, with said device comprising;
a one and a quarter inch housing, semi circular in shape, with a flat fascia displaying the registered ID number of the handicap person. Including an upwardly extending finger formed in an inverted J-shape to define a hook that will hang to the right on the support arm of the rear view mirror of an automobile. Allowing the registered ID and the international handicap accessibility insignia to be displayed whether looking in the automobile from the front windshield or the rear window when in a fully displayed pulled down manner. As well as a pull down tab with a connected cord indicating the international handicap accessibility insignia extending from said bottom end of said placard to enable operation of said spring loaded roll and movement of said placard between a relaxed state with said placard retracted within said housing and a selected locked position when in a fully extended position, circular circumference being approximately three quarters of an inch in diameter. All of which must be displayed in the color of blue, with the ID number and handicap man insignia being displayed in the color of white in order to meet law enforcement requirements. Of course the said registered ID number supplied by a municipal motor vehicle department, specifically registered to and identifying the handicap persons permit, and said decal of this ID number corresponding to said indicia [decal] on said placard.

2. A device for displaying a disabled parking permit within an automobile having a rear view mirror held on the support arm of said mirror, said device comprising;
a housing [in the color of blue] including an upwardly extending finger formed in a inverted J-shape to define a hook for supported engagement over the support arm in order to hang the device from the support arm of the rear view mirror of an automobile, and said housing having an interior chamber and a slot opening communicating with said interior chamber;
a spring loaded roll rotatably supported within said interior chamber of said housing and said spring loaded being rotatably operable from a relaxed state against a spring-biased force to a selected locked position;
a flexible sheet substrate [in the color of blue with all indicia printed in the color of white] defining a placard and including a front face, a rear face, and said indicia representing the disabled parking permit in said colors;
said top end of said placard being attached to said spring-loaded roll and said placard being wound about said spring-loaded roll so that said placard is contained within said interior chamber of said housing and concealed within said housing when said spring-loaded roll is in a said relaxed state, and said placard being extendable out through said slot opening and against said spring-biased force to a fully extended position at said selected locked position of said spring-loaded roll to visibly expose said said front and rear faces of said placard and said disabled parking permit provide by said indicia;
said spring loaded roll being selectively operable from said locked position to said relaxed position to cause said placard to be retracted through said slot opening and into said interior chamber and wound about said spring-loaded roll, thereby concealing said placard; and
said semi-circular housing including a partial flat fascia of surface portion defining a designated area for attachment of a municipal supplied registered ID number decal thereto, and said decal having indicia corresponding to said indicia on said placard.
